(19) United States
(12) Patent Application Publication
(10) Pub. No.: US 2009/0132747 A1
(43) Pub. Date: May 21, 2009

(54) STRUCTURE FOR UNIVERSAL PERIPHERAL PROCESSOR SYSTEM FOR SOC ENVIRONMENTS ON AN INTEGRATED CIRCUIT

(75) Inventors: Serafino Bueti, Waterbury, VT (US); Kenneth J. Goodnow, Essex Junction, VT (US); Todd E. Leonard, Williston, VT (US); Gregory J. Mann, Wheaton, IL (US); Jason M. Norman, Essex Junction, VT (US); Clarence R. Ogilvie, Huntington, VT (US); Peter A. Sandon, Essex Junction, VT (US); Charles S. Woodruff, Charlotte, VT (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 12/122,289

(22) Filed: May 16, 2008

Related U.S. Application Data
(63) Continuation-in-part of application No. 11/942,000, filed on Nov. 19, 2007.

(51) Int. Cl. G06F 13/14

(52) U.S. Cl. 710/305

(57) ABSTRACT

A design structure including universal peripheral processor architecture on an integrated circuit (IC) includes first and second data buses coupled to interface logic devices for enabling communication between the first and second data buses including enabling interface of multiple signaling protocols. One or more processors communicate with the first and second data buses to manage control functions on the IC. A data path enables transfer of data between the first and second data buses, and communicates with data storage devices. A data control path enables communication between the data storage devices and the processors.

### CROSS-REFERENCE TO RELATED APPLICATION

This application is a continuation-in-part of co-pending and co-assigned U.S. patent application Ser. No. 11/942,000, filed Nov. 19, 2007, currently pending.

### FIELD OF THE INVENTION

The invention relates to universal processor architecture on an integrated circuit, and more particularly, a microprocessor as an interface between a processor and a plurality of bus elements each having a protocol.

### BACKGROUND OF THE INVENTION

Processor systems for system-on-chip (SOC) environments on an Integrated Circuit may use a software based architecture for a generic peripheral processor. However, in practice, the usefulness of this architecture may be limited by protocol requirements of multiple buses (peripheral buses, data buses). For example, if the protocol of the bus requires responses from a microcontroller (MCU or uController) within a single cycle, the uController may not have the processing capacity (bandwidth) to meet the specified response time.

An IP (intellectual property) core is a block of logic or data that is used in making a field programmable gate array (FPGA) or application-specific integrated circuit (ASIC) for a product. Also, a core IP library is a library of logic designs implementing different functions (eg: PCI Core, UART Core, SRAM Core). A core IP library contains a multitude of unique designs that are costly to design, maintain, and migrate from technology to technology nodes. However, the core IP library is needed in an application-specific integrated circuit (ASIC) design function. An ASIC is customized for a particular use. Typically, the functions traverse from multiple IC's (integrated circuits) to single IC's, or a piece of an IC, or to code in the processor on the IC.

Bus adapters between high-speed interfaces are typically implemented using dedicated circuits, for example, within an ASIC. If a flaw is discovered within this dedicated circuit or an interface protocol changes, the ASIC must be redesigned and manufactured at an expense, and significant impact on the length of time it takes for a product to be available for sale (time-to-market).

Peripheral processors or microcontrollers provide the processing necessary to translate one bus standard to another. These processors typically are not the main processors of a system, but are dedicated to handling interface translations. Using these peripheral processors allows certain peripheral cores or microcontrollers to be replaceable which previously were built with dedicated circuits. Peripheral cores typically use dedicated circuits for performance and size reasons. Bus protocols require state-tracking which was typically handled by dedicated circuits that could handle the performance requirements.

When using a generic microprocessor to replace a peripheral core, processor, or microcontroller, the variety of protocols which can be supported will depend, among other things, on the performance of the microprocessor. Within a given technology node, this microprocessor can dedicate some maximum number of cycles to analyzing and responding to various states of the peripheral interface. For complex or fast interfaces, this maximum number of cycles completed by the microprocessor by may not be sufficient to analyzing and responding to various states of the peripheral interface.

A recurring problem and expense in the development of new ASIC integrated circuit technologies, is migrating previously developed Intellectual Property (IP) or functions from the older technology to the newer technology. Typically, a core IP library contains a multitude of unique designs that are costly to design, maintain, and migrate from technology to technology nodes, yet serve a useful and vital role in the ASIC integrated circuit design function. The development work for the ASIC requires synthesis, timing, and verification and is almost always redeveloped during the migration to a newer technology, not added on to the older technology. Thus, the development cost for a new technology is always greater than the cost of just adding new IP.

In the digital electronics field, there has been an increasing integration of function onto the integrated circuit. This is accomplished in two ways, the first is through more transistors and thus, more function capability on the integrated circuit. The second way is through an increase in speed provided by the transistors which allows use of a processing engine that takes generic instructions, and implements a function through a specified sequence of these instructions.

Currently, ASIC design includes high level functions, for example, bus protocol translation, file decompression, encryption, etc., implemented as standalone sub-blocks comprised of a sea of gates. Usually these functions are implemented as a collection of state machines and data paths with registers to move data from input to output. The typical ASIC IP library may consists of over two hundred of these functions. For example, as a new technology emerges all of these two hundred or more functions need to be migrated to the new technology. The migration of the functions incurs costs associated with the rework of the sub-blocks and their gate implementations.

It would therefore be desirable to handle functions using software. It would also be desirable to reduce development time and expense. It would further be desirable to increase efficiency of programming. Further, it would also be desirable to provide a software architecture for controlling multiple protocols from respective buses. It would further be desirable to replace an originally developed Intellectual Property (IP) or IP core library with a small set of generic software based universal processing (UP) cores that are configurable to meet multiple core IP functions.

### SUMMARY OF THE INVENTION

The present invention relates to a universal peripheral processor system architecture on an integrated circuit (IC) which comprises a first data bus and a second data bus. A processor device is coupled to the first and second data buses for managing control functions on an IC. A data path enables transfer of data between the first and second data buses and the data path also communicates with a data storage device. A data control path enables communication between and is coupled to the data storage device, and the processor.

In a related aspect, the processor further comprises an interface logic device coupled to the processor and the data control path.

In a related aspect, the interface logic device is a microcontroller, and the microcontroller may be connected to a translation unit for processing interface translations.

In a related aspect, the interface logic device enables communication between the first and second data buses including enabling interface between multiple signaling protocols.

In a related aspect, the processor further comprises a protocol translation device coupled to the processor.

In a related aspect, the data storage device includes a first-in, first-out (FIFO) storage protocol.

In a related aspect, the processor further includes at least two clock domains and a plurality of meta-stability devices communicating with the processor to provide interface between the clock domains and the processor.

In a related aspect, the processor further comprises at least two protocol translation devices coupled to the processor and coupled to the data path.

In a related aspect, the processor further includes a plurality of data storage devices.

In a related aspect, the processor of claim 1 further comprises multiple processors coupled to the first and second data buses for managing control functions on the IC.

In a related aspect, the processor further comprises a protocol translation device coupled to the interface logic device.

In a related aspect the processor further comprises first and second interface logic devices coupled to first and second processors located in first and second clock domains, respectively, and the first and second data buses, respectively.

In a related aspect, the processor further includes a plurality of meta-stability devices communicating with the first and second interface logic devices to provide interface between the clock domains and the first and second processors.

In another aspect of the invention, a universal peripheral processor architecture on an integrated circuit (IC) comprises a first data bus and a second data bus. The first and second data buses are coupled to first and second interface logic devices, respectively, for enabling communication between the first and second data buses including enabling interface between multiple signaling protocols. A first processor and a second processor are included for managing control functions on the IC and are coupled to the first and second interface logic devices, respectively. A data path enables transfer of data between the first and second data buses, and the data path also communicates with a plurality of data storage devices. A data control path enables communication between and coupled to the data storage devices, the first and second processors, and the first and second interface logic devices.

In a related aspect, the first and second data buses communicate with each other and the plurality of storage devices via a plurality of data paths.

In a related aspect, the first and second interface logic devices are located in first and second clock domains, respectively.

In a related aspect, the processor further comprises a plurality of meta-stability devices communicating with the first and second processors to provide an interface between the first and second clock domains and the first and second processors.

In a related aspect, the first and second interface logic devices are microcontrollers and the data storage devices include FIFOs.

In a related aspect, the first interface logic device is coupled to the first data storage device and is adapted to interface between the first processor and the first data bus using a first predefined protocol. The second interface logic device is coupled to the second data storage device and adapted to interface between the second processor and the second data bus using a second predefined protocol.

In a related aspect, the first data bus and first interface logic device are in a first clock domain and the second data bus and the second interface logic device are in a second clock domain. At least one meta-stability device communicates with and provides interface between the first and second data buses and the first and second processors.

In a related aspect, the processor further includes first and second transformers to provide data conversion between the first and second protocols of the first and second data buses, respectively. The first and second transformers communicate with first and second data storage devices, respectively, via a plurality of data paths and communicate with the first and second processors, respectively, via a plurality of control paths.

In a related aspect, the first and second data buses communicate with each other and the first and second storage devices via a plurality of data paths.

In another aspect of the invention a method for enabling a peripheral processor on an IC to provide an interface between multiple data buses comprises: providing a first data bus and a second data bus; coupling the first and second data buses to first and second interface logic devices, respectively; communicating data between the first and second data buses including enabling interface of multiple signaling protocols; managing control functions using a first processor and a second processor on the IC and the first and second processors being coupled to the first and second interface logic devices, respectively; transferring data using a data path between the first and second data buses; storing data in a plurality of data storage devices communicating with the data path; and communicating data via a data control path between and the data storage devices, the first and second processors, and the first and second interface logic devices.

A design structure including universal peripheral processor architecture embodied in a machine medium for designing, manufacturing, or testing an integrated circuit (IC), the design structure includes a first data bus and a second data bus, and a processor coupled to the first and second data buses for managing control functions on an IC. A data path enables transfer of data between the first and second data buses. A data storage device is in communication with the data path for storing data. A data control path enables communication between and coupled to the data storage device, and the processor.

In a related aspect, the design structure further comprises an interface logic device coupled to the processor and the data control path, and the interface logic device is a microcontroller. The microcontroller may be connected to a translation unit for processing interface translations. The interface logic device may enable communication between the first and second data buses including enabling interface between multiple signaling protocols, and a protocol translation device is coupled to the processor. The data storage device may include a FIFO. The first and second data buses may operate in respective clock domains, and the peripheral processor further comprises a plurality of meta-stability devices communicating with the processor to provide interface between the clock domains and the processor. The design structure may further comprise at least two protocol translation devices coupled to the processor and coupled to the data path. The design structure may further include a plurality of data storage devices. Additionally, the design structure may further comprise multiple processors coupled to the first and second data buses for managing control functions on the IC, and the design structure may further comprise a protocol translation device coupled to the interface logic device. Also, the design structure may further comprise first and second interface logic devices coupled to first and second processors located in first and second clock domains, respectively, and the first and second data buses, respectively, and the design structure may further include a plurality of meta-stability devices communicating with the first and second interface logic devices to provide interface between the clock domains and the first and second processors. The design structure may comprise a netlist, and/or reside on storage medium as a data format used for the exchange of layout data of integrated circuits, and/or the design structure may reside on a programmable gate array.

In another aspect of the invention, the design structure includes universal peripheral processor architecture embodied in a machine readable medium for designing, manufacturing, or testing an integrated circuit (IC), and the design structure comprises a first data bus and a second data bus. The first and second data buses are coupled to first and second interface logic devices, respectively, for enabling communication between the first and second data buses including enabling interface between multiple signaling protocols. A first processor and a second processor for manage control functions on the IC and being coupled to the first and second interface logic devices, respectively. A data path enables transfer of data between the first and second data buses, wherein the data path also communicates with a plurality of data storage devices. A data control path enables communication between and coupled to the data storage devices, the first and second processors, and the first and second interface logic devices.

In a related aspect, the first and second data buses communicate with each other and the plurality of storage devices via a plurality of data paths. The first and second interface logic devices may be located in first and second clock domains, respectively. The design structure may further comprise a plurality of meta-stability devices communicating with the first and second processors to provide interface between the first and second clock domains and the first and second processors. The first and second interface logic devices may be microcontrollers and the data storage devices may include FIFOs. The first interface logic device may be coupled to the first data storage device and adapted to interface between the first processor and the first data bus using a first predefined protocol. The second interface logic device may be coupled to the second data storage device and adapted to interface between the second processor and the second data bus using a second predefined protocol. The first data bus and first interface logic device may be in a first clock domain and the second data bus and the second interface logic device may be in a second clock domain, and at least one meta-stability device communicates with and provides interface between the first and second data buses and the first and second processors. The design structure may further include first and second transformers to provide data conversion between the first and second protocols of the first and second data buses, respectively, and the first and second transformers may communicate with first and second data storage devices, respectively, via a plurality of data paths and communicate with the first and second processors, respectively, via a plurality of control paths, and the first and second data buses may communicate with each other and the first and second storage devices via a plurality of data paths.

In a related aspect, the design structure may comprise a netlist, and/or the design structure may reside on storage medium as a data format used for the exchange of layout data of integrated circuits, and/or the design structure may reside on a programmable gate array.

### BRIEF DESCRIPTION OF THE DRAWINGS

FIG. 1 is a block diagram of a universal peripheral processor according to an embodiment of the invention using multiple microcontrollers;

FIG. 2 is a block diagram of a universal peripheral processor according to another embodiment of the invention using a single microcontroller;

FIG. 3 is a block diagram of a universal peripheral processor according to yet another embodiment of the invention using multiple microcontrollers and a single protocol translation unit; and

FIG. 4 is a flow diagram of a design process used in semiconductor designing, manufacture and/or testing.

### DETAILED DESCRIPTION OF THE INVENTION

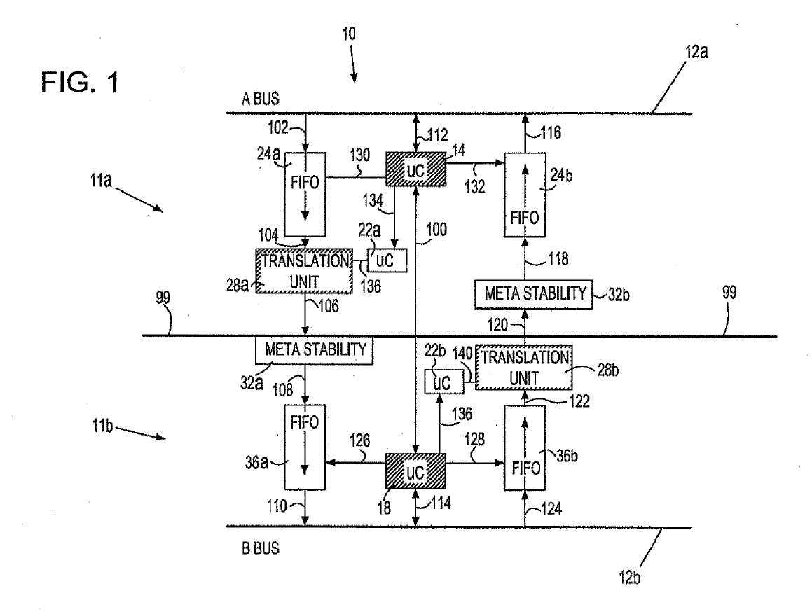

The present invention provides a multiprocessor/processor architecture that accomplishes a peripheral function using a software code execution, i.e., a device or system providing a universal peripheral processor. As shown in FIG. 1, the embodiment of the universal peripheral processor system of the present invention generally includes: a processor and/or multiple processors that implement control; FIFO memory structures that handle the data flow; a translation unit that handles the data manipulation from one format to another; hardening of structure into physical design data; and software coding of different peripheral functions to implement function. The universal peripheral processor of the present invention accesses an external peripheral bus and controls the work associated with the peripheral bus control signals.

An exemplary embodiment of the present invention is shown in FIG. 1 and includes a universal processor architecture comprising a first data bus 12a and a second data bus 12b whereby a dataflow path from the first bus 12a to the second bus 12b is controlled by a signal from the first bus 12a. However, the invention is not so limited and may be controlled by a signal from second bus 12b. The system includes a peripheral microcontroller 14 interfacing with data bus A 12a and a peripheral microcontroller 18 interfacing with data bus 12b. Each microcontroller 14 and 18 are connected with microcontrollers 22a and 22b, respectively. Data path 100 provides communication between microprocessors 14, 18.

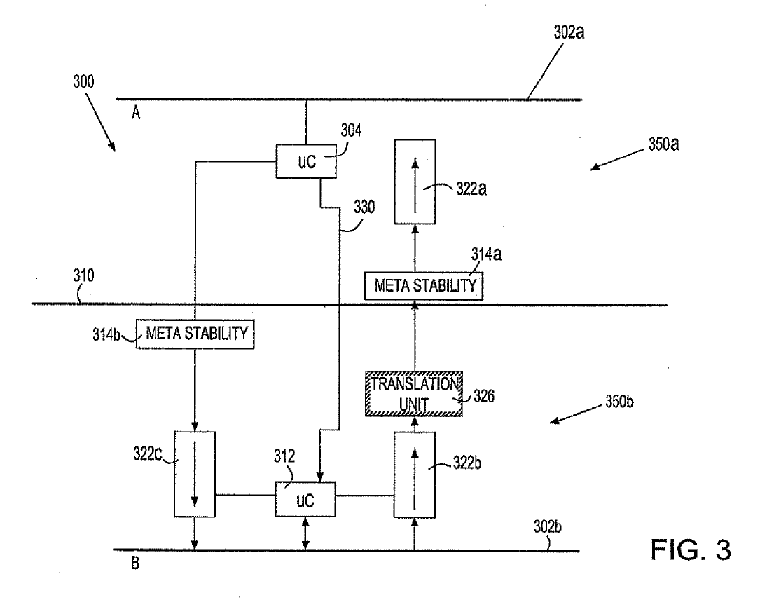

The peripheral processors or microcontrollers 14 and 18 provide all processing necessary (as in the embodiment shown in FIG. 3 and discussed herein), including state-tracking of the bus protocols, and translating one bus standard to another, i.e., bus A to bus B protocol and vice versa in the embodiment of the present invention shown in FIG. 1. However, peripheral processors or microcontrollers 22a, 22b are alternatively added in the embodiment of the universal peripheral processor system shown in FIG. 1. Microcontrollers 22a, 22b are additional processors used by the universal peripheral processor system, and in the embodiment shown in FIG. 1, are dedicated to handling interface translations from translation units 28a and 28b, respectively, to allow the microcontrollers 14, 18 to process functions other than interface translations.

Further, referring to FIG. 1, the peripheral multiprocessor system includes two mirrored microprocessor architectures/systems having their own clock domains 11a and 11b divided along a fictitious dividing line 99 within the system 10 for conceptualizing the two clock domains 11a and 11b. The clock domains 11a and 11b operate at the same or different clock/bus speeds. Each of the mirrored microprocessor architectures 11a, 11b comprise microprocessors (PP) 22a and 22b and microprocessors 14, 18. Microprocessors 14, 18 are directly connected to data storage FIFOs 24a, 24b and 36a, 36b, via data paths 130, 132, and 126, 128, respectively. FIFO 24a receives data from Bus A 12a in system/clock domain 11a along data path 102. Data paths 104 and 106 have translation unit 28a therebetween and communicate with FIFO 36a via data path 108 after passing through meta stability device 32a. The meta-stability devices 32a, 32b provide interface between the clock domains 11a, 11b and the processors 14, 18, 22a, 22b. Further, the microprocessors 14, 18 are connected to their respective data/control buses A and B, respectively. The data/control buses A, B are intended to carry both data and control signals. It is understood that separate data control paths for systems 11a and 11b may be used in accordance with the embodiment of the invention shown in FIG. 1, instead of single data/control buses 12a, 12b.

The FIFOs are illustrative of data storage devices which may be used in the multiprocessor/processor architecture according to the present invention. FIFO 36a is connected to the microcontroller 18 via control path 126 and connected to the meta stability device 32a via control path 108. The FIFO 36a receives data from the microcontroller 18 and/or microcontroller 28a via translation unit 28a and metastability device 32a, and connects directly to data bus B 12b via data path 110 for transferring data thereto. Translation units 28a and 28b are directly connected to microcontrollers 22a, 22b via data paths 136, 140, respectively. The translation units 28a, 28b perform data transformations between data bus A 12a and data bus B 12b. FIFOs 24a, 24b, 36a, 36b are memory structures which are able to bring information from the external buses A 12a and B 12b and hold the information until required. The FIFOs may be optimized for different peripheral functions or application.

In general a FIFO refers to, first-in, first-out, which is an approach to handling program work requests from queues or stacks so that the oldest request is handled next. The FIFOs 24a, 24b and 36a, 36b pull data off the data buses 12a, 12b, respectively. The translation units 28a, 28b enable the movement of data from one type of information to another. For example, an eight bit block of data can be translated into a sixteen bit block of data (for example, a data shifter).

The present invention eliminates problems associated with using a processor(s) as a core(s). Further, the present invention replaces an IP core library with a set of generic software in universal processing (UP) cores that are configurable to meet multiple core IP functions. Generally, a microprocessor or microcontroller according to the present invention may be a simplified version of a processor. For example, an eight bit operating code (opcode) word width may be sufficient. The processors 14 and 18 include software driven logic which includes, for example, the following functions: branch ability; input recognition ability to determine the bus states; output control to assert bus states; and FIFO control, as well as, normal processor functions such as fetching opcodes and basic Boolean manipulations.

The translation units 28a and 28b are used to minimize the amount of computation the microcontrollers 22a, 22b need to perform. The microcontrollers 14, 22a and 18, 22b in different clock domains 11a and 11b, respectively, prefer data to be formatted in a variety of ways as well as some simple calculations performed on the data. To address this issue, the translation units 28a, 28b provide a block of logic which can perform generic transforms on the data as it moves from one FIFO 36b, to another FIFO 24b, for example.

For example, the translation units 28a, 28b can provide transforms including: change of Endianness, which generally refers to sequencing methods used in a one-dimensional system (such as writing or computer memory); data width conversion (i.e. 1 byte put per cycle=>4 bytes fetched every fourth cycle); parity bit generation and checking; CRC remainder generation; field masking; and address translation.

The translation units 28a, 28b can be implemented as either a single generic block which can implement all transforms, or can be configured to run any subset of the transforms. The configuration of the translation units 28a, 28b may include bit-wise crossbar switches or another small microcontroller.

Processor memory is not shown in FIG. 1, however, it is envisioned that the software coding may be in bytes or words of data and can be stored in some type of memory structure. The memory structure, for example, may be implementation dependent, and could be implemented in multiple ways, for example: local ROM memory; local flash or SRAM memory; global ROM, flash, or SRAM memory; and external ROM, flash, or SRAM memory. Local memory generally refers to structure physically located close to the universal processor. Global memory generally refers to a structure that is part of the IC (integrated circuit) or SOC (system on a chip) structure. Further, external memory is generally a memory structure that is external to the integrated circuit. One constraint regarding a global memory source pertains to the access time being compatible with the processor speed in the particular application, for example, a slow simple interface does not need a fast code memory source. The access time could even be more problematic with the use of an external source due to delays through the I/O (input/output) devices (not shown).

The universal processor according to the present invention may be built as shown in FIG. 1, and the logic can then be hardened, i.e., placing and wiring the transistors on the IC, and creating the different levels of the IC. The level information may be stored in a GDSII format (GDSII is a database format which is a standard for IC layout data exchange) that can be placed on an ASIC (application specific integrated circuit) design as an integrated whole. The design of the SOC (system on a chip) would call for one or multiple instances of the universal peripheral processor architecture. Thus, in the universal peripheral processor architecture of the present invention the structure, as embodied in FIG. 1, is implemented as a hardened structure on an ASIC or IC.

The software code memory structures would be implemented according to the processor speed and overall architecture of the SOC. Each of the universal peripheral processors would have the I/O device connections to each bus side. The software for each universal peripheral processor is loaded into the software code memory structures.

In a variation of the embodiment of the peripheral processor shown in FIG. 1, if one interface, for example microcontroller 14 is very slow, processing can be done by another microcontroller, in this embodiment, microcontroller 18. In a traffic dependent dynamic example, the microcontroller 14 could switch to a low-power mode while microcontroller 18 processes the incoming data. When traffic increases, the microcontroller 14, in low-power mode, wakes-up.

An advantage of the present invention is the provision of a generic core which can be configured to the needs of multiple existing core functions. Another advantage of the present invention is that it includes implementing a software solution as opposed to hardware development which is more cost effective. Further, a transition from one technology to another may require only a generic hardware remap and/or specific changes can be rewritten in software. Program bugs may reside in the software and thus fixes can be implemented in the software which is more cost effective than correcting hardware failures.

An advantage of the universal peripheral processor architecture of the present invention is a single logic structure to be developed for each technology. Another advantage is a library of peripheral functions developed in software. Another advantage is if a problem in the peripheral implementation occurs, it can be fixed by updating the software, and not requiring an IC change.

Another advantage of the peripheral processor of the present invention is the ability of a peripheral implementation being updating using software and not respinning the IC. The peripheral processor according to the present invention can also be advantageously used when debugging a system under design by using the peripheral processor in the process of hardware emulation to imitate the behavior of a piece of hardware. Another advantage of the peripheral processor is that custom ICs may be created at a peripheral level without respinning the IC. A further advantage of the peripheral processor is that support requirements for implementing the peripheral processor is minimized because the same physical macro can be reused.

Thus, the universal peripheral processor architecture of the present invention significantly reduces expenses when developing new ASIC integrated circuit technologies because migrating previously developed Intellectual Property (IP) or functions from older technology is more efficient. For example, the universal peripheral processor saves time and costs of synthesis, timing, and verification during the migration to a newer technology.

Further, the universal peripheral processor architecture of the present invention discloses an architecture that allows functions to be handled using software. Thus, the peripheral library would be a set of software programs capable of being run on the same processor. This base processing element would be the only piece of IP that would need to be migrated from one technology to the next.

The architecture according to the present invention includes having the same universal processor used for multiple functions which provides efficiency of programming and reuse. The type of bus functions that can be used, for example, are legacy serial, bridge, multi-serial, data mover, and data manipulation bus functions. The processor architecture is maximized for implementing a function with microprocessor architecture/system 11a as one part of the architecture and then communicating the inputs and outputs to microprocessor architecture/system 11b as a second part of the architecture. Further, the multiprocessor/processor structure is hardened into a technology for maximum performance and size benefits.

Thus, the universal processor architecture according to the present invention allows a given peripheral function to be implemented in software and run on the processors. The invention provides a processor structure that is implemented to achieve peripheral functions. The present invention includes a multiprocessor/processor architecture (universal peripheral processor) that would accomplish a given peripheral function by means of software code execution. This processor architecture may be maximized for implementing a function with one part of the architecture, and then communicating the inputs and outputs through a second part of the architecture.

An example of a processor architecture maximized for implementing a function with one part of the architecture and communicating the inputs and outputs through a second part of the architecture includes a Logic Link Control LLC bus interface that is attached to, for example, a RISC microprocessor or PowerPC® architecture in an SOC environment. LLC (Logical Link Control) is the upper sublayer of an OSI data link layer. The Open System Interconection (OSI) model divides the functions of a protocol into a series of layers. Each layer only uses the functions of the layer below, and only exports functionality to the layer above. A system that implements protocol behavior consisting of a series of these layers is known as a “protocol stack” or “stack”. The LLC is the same for the various physical media (such as Ethernet, token ring, WLAN). The LLC sublayer is primarily concerned with multiplexing protocols transmitted over the MAC layer (when transmitting) and demultiplexing them (when receiving) optionally providing flow control, and detection and retransmission of dropped packets, if requested. Thus, one part of the processor architecture can handle the LLC communication protocols and signals, while the other part of the processor can handle the communication with the data bus.

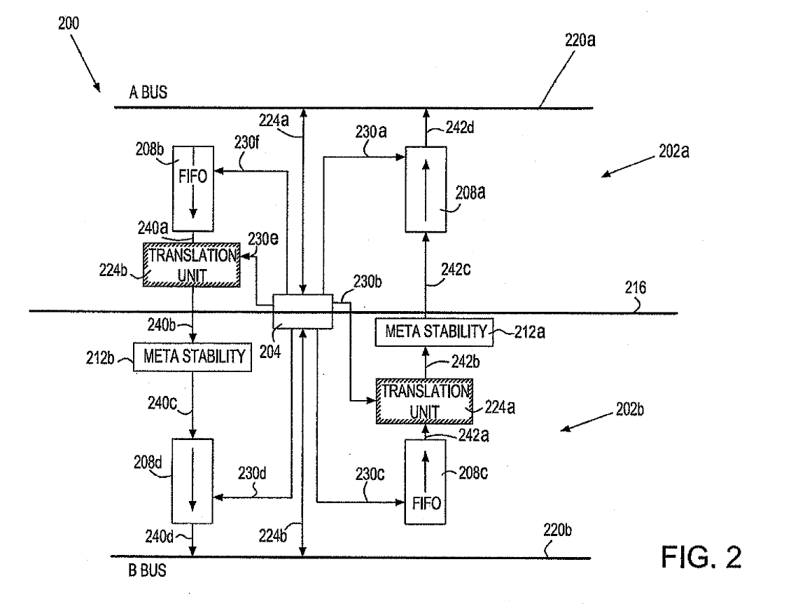

Referring to FIG. 2, in another embodiment according to the present invention, a universal peripheral processor system 200 includes a single processor 204 connected to FIFOs 208a and 208b in one clock domain 202a on one side of metastability devices 212a and 212b along a fictitious line 216 within the system 200 to conceptualize the clock domains 202a and 202b. The FIFOs 208a and 208b, in the first clock domain 202a, ultimately communicate with FIFOs 208c and 208d in the second clock domain 202b on the opposite side of line 216. More specifically, FIFO 208b communicates with FIFO 208d along data paths 240a, 240b, 240c passing through the translation unit 224b and metastability device 212b. Similarly, FIFO 208c communicates with FIFO 208a along data paths 242a, 242b, and 242c passing through the translation unit 224a and metastability device 212a. The single processor 204 computes for both domains 202a and 202b simultaneously, and thus has the processing speed required to accomplish the task of computing for both clock domains 202a, 202b. The processor 204 further processes interface translations from translation units 224a and 224b via connections 230b and 230e, respectively. Contrary to the peripheral processor 10 shown in FIG. 1, which included processors 14 and 18 connected to buses A and B, respectively, the peripheral processor 200 shown in FIG. 2, includes one processor 204 connected to both buses A 220a and B 220b via data paths 224a and 224b. The system 200 thereby uses one processor 204 to process and control the data from both data buses A 220a and B 220b.

Referring to FIG. 3, in another embodiment according to the present invention, a universal peripheral processor system 300 includes a microcontroller 304 in clock domain A 350a on one side of a fictitious demarcation line 310 within the system 300 for conceptually dividing the two clock domains 350a and 350b. FIFO 322a in clock domain A 350a is connected to data bus B 302a and meta stability device 314a. Another microcontroller 312 in clock domain B 350b is connected to FIFOs 322b and 322c, and the microcontrollers 304 and 312 are connected via data path 330. A translation unit 326 is connected to FIFO 322b and meta stability device 314a. Metastability devices 314a and 314b are positioned along demarcation line 310. The system 300 thereby uses two processors 304, 312, one in each clock domain 350a, 350b, respectively, to process and control the data from data buses A 302a and B 302b.

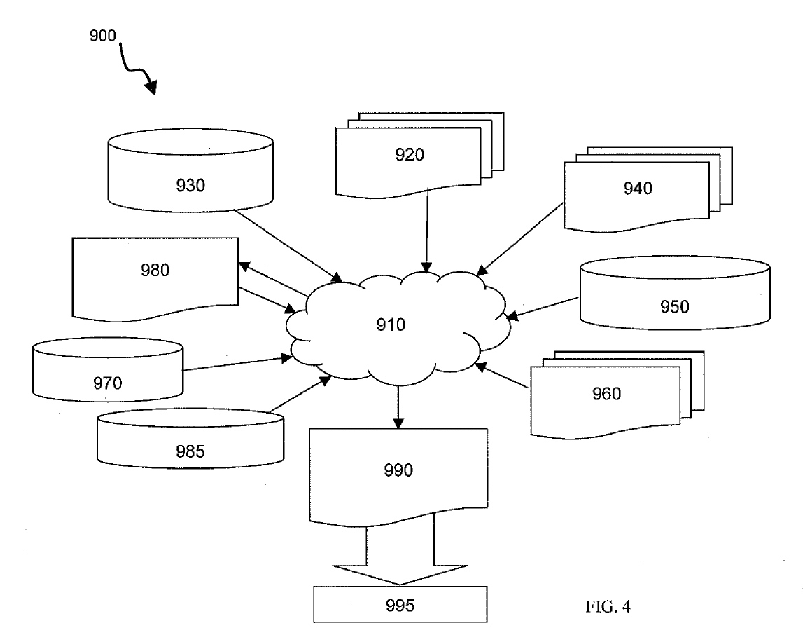

FIG. 4 shows a block diagram of an exemplary design flow 900 used for example, in semiconductor design, manufacturing, and/or test. Design flow 900 may vary depending on the type of IC being designed. For example, a design flow 900 for building an application specific IC (ASIC) may differ from a design flow 900 for designing a standard component or from a design from 900 for instantiating the design into a programmable array, for example a programmable gate array (PGA) or a field programmable gate array (FPGA) offered by Altera® Inc. or Xilinx® Inc. Design structure 920 is preferably an input to a design process 910 and may come from an IP provider, a core developer, or other design company or may be generated by the operator of the design flow, or from other sources. Design structure 920 comprises an embodiment of the invention as shown in FIGS. 1-3 in the form of schematics or IDL, a hardware-description language (e.g., Verilog, VHDL, C, etc.). Design structure 920 may be contained on one or more machine readable medium. For example, design structure 920 may be a text file or a graphical representation of an embodiment of the invention as shown in FIGS. 1-3. Design process 910 preferably synthesizes (or translates) an embodiment of the invention as shown in FIGS. 1-3 into a netlist 980, where netlist 980 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 980 is resynthesized one or more times depending on design specifications and parameters for the circuit.

Design process 910 may include using a variety of inputs; for example, inputs from library elements 930 which may house a set of commonly used elements, circuits, and devices, including models, layouts, and symbolic representations, for a given manufacturing technology (e.g., different technology nodes, 32 nm, 45 nm, 90 nm, etc.), design specifications 940, characterization data 950, verification data 960, design rules 970, and test data files 985 (which may include test patterns and other testing information). Design process 910 may further include, for example, standard circuit design processes such as timing analysis, verification, design rule checking, place and route operations, etc. One of ordinary skill in the art of integrated circuit design can appreciate the extent of possible electronic design automation tools and applications used in design process 910 without deviating from the scope and spirit of the invention. The design structure of the invention is not limited to any specific design flow.

Design process 910 preferably translates an embodiment of the invention as shown in FIGS. 1-3, along with any additional integrated circuit design or data (if applicable), into a second design structure 990. Design structure 990 resides on a storage medium in a data format used for the exchange of layout data of integrated circuits and/or symbolic data format (e.g. information stored in a GDSII (CDS2), CL1, OASIS, map files, or any other suitable format for storing such design structures). Design structure 990 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 1-3. Design structure 990 may then proceed to a stage 995 where, for example, design structure 990: proceeds to tape-out, is released to manufacturing, is released to a mask house, is sent to another design house, is sent back to the customer, etc.

While the present invention has been particularly shown and described with respect to preferred embodiments thereof it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A design structure including universal peripheral processor architecture embodied in a machine readable medium for designing, manufacturing, or testing an integrated circuit (IC), the design structure comprising:
a first data bus and a second data bus;
a processor coupled to the first and second data buses for managing control functions on an IC;
a data path enabling transfer of data between the first and second data buses;
a data storage device in communication with the data path for storing data; and
a data control path enabling communication between and coupled to the data storage device, and the processor.

2. The design structure of claim 1, Her comprising an interface logic device coupled to the processor and the data control path, and
the interface logic device is a microcontroller.

3. The design structure of claim 3, wherein the microcontroller is connected to a translation unit for processing interface translations.

4. The design structure of claim 1, wherein the interface logic device enables communication between the first and second data buses including enabling interface between multiple signaling protocols, and
a protocol translation device is coupled to the processor.

5. The design structure of claim 1, wherein the data storage device includes a FIFO.

6. The design structure of claim 1, wherein the first and second data buses operate in respective clock domains, and the peripheral processor further comprises a plurality of meta-stability devices communicating with the processor to provide interface between the clock domains and the processor.

7. The design structure of claim 1, further comprising at least two protocol translation devices coupled to the processor and coupled to the data path.

8. The design structure of claim 1, further including a plurality of data storage devices.

9. The design structure of claim 1, further comprising multiple processors coupled to the first and second data buses for managing control functions on the IC, and the design structure further comprising a protocol translation device coupled to the interface logic device.

10. The design structure of claim 1, further comprising first and second interface logic devices coupled to first and second processors located in first and second clock domains, respectively, and the first and second data buses, respectively, and the design structure
further including a plurality of meta-stability devices communicating with the first and second interface logic devices to provide interface between the clock domains and the first and second processors.

11. The design structure of claim 1, wherein the design structure comprises a netlist.

12. The design structure of claim 1, wherein the design structure resides on storage medium as a data format used for the exchange of layout data of integrated circuits.

13. The design structure of claim 1, wherein the design structure resides on a programmable gate array.

14. A design structure including universal peripheral processor architecture embodied in a machine readable medium for designing, manufacturing, or testing an integrated circuit (IC), the design structure comprising:
a first data bus and a second data bus wherein the first and second data buses are coupled to first and second interface logic devices, respectively, for enabling communication between the first and second data buses including enabling interface between multiple signaling protocols;
a first processor and a second processor for managing control functions on the IC and being coupled to the first and second interface logic devices, respectively;
a data path enabling transfer of data between the first and second data buses, wherein the data path also communicates with a plurality of data storage devices; and
a data control path enabling communication between and coupled to the data storage devices, the first and second processors, and the first and second interface logic devices.

15. The design structure of claim 14, wherein the first and second data buses communicate with each other and the plurality of storage devices via a plurality of data paths.

16. The design structure of claim 14, wherein the first and second interface logic devices are located in first and second clock domains, respectively.

17. The design structure of claim 14, further comprising a plurality of meta-stability devices communicating with the first and second processors to provide interface between the first and second clock domains and the first and second processors.

18. The design structure of claim 14, wherein the first and second interface logic devices are microcontrollers and the data storage devices include FIFOs.

19. The design structure of claim 14, wherein the first interface logic device is coupled to the first data storage device and adapted to interface between the first processor and the first data bus using a first predefined protocol; and
the second interface logic device is coupled to the second data storage device and adapted to interface between the second processor and the second data bus using a second predefined protocol,
wherein the first data bus and first interface logic device are in a first clock domain and the second data bus and the second interface logic device are in a second clock domain, and at least one meta-stability device communicates with and provides interface between the first and second data buses and the first and second processors, and the design structure
further including first and second transformers to provide data conversion between the first and second protocols of the first and second data buses, respectively, wherein the first and second transformers communicate with first and second data storage devices, respectively, via a plurality of data paths and communicate with the first and second processors, respectively, via a plurality of control paths, wherein the first and second data buses communicate with each other and the first and second storage devices via a plurality of data paths.

20. The design structure of claim 14, wherein the design structure comprises a netlist, wherein the design structure resides on storage medium as a data format used for the exchange of layout data of integrated circuits, and wherein the design structure resides on a programmable gate array.
